(19) United States
(12) Patent Application Publication
(10) Pub. No.: US 2011/0007498 A1
(43) Pub. Date: Jan. 13, 2011

(54) ILLUMINATION DEVICE WITH A SOLAR CELL

(75) Inventor: Christine Maier, Asselfingen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/832,125

(22) Filed: Jul. 8, 2010

(30) Foreign Application Priority Data
Jul. 10, 2009 (DE) 102009032544.1

(51) Int. Cl. F21L 4/02

(52) U.S. Cl. 362/183

(57) ABSTRACT

An illumination device may include a multilayer system having at least two functional layers, a supporting functional layer having a sheet-like substrate on which a photovoltaic functional layer with at least one solar cell is applied; at least one energy storage device for storing energy generated by the at least one solar cell; at least one light source that can be operated by means of the energy stored in the energy storage device; and at least one brightness sensor. The illumination device may be configured to activate or deactivate the at least one light source on the basis of a measured value sensed by the at least one brightness sensor.

### CROSS-REFERENCE TO RELATED APPLICATION

This application claims priority to German Patent Application Serial No. 10 2009 032 544.1, which was filed Jul. 10, 2009, and is incorporated herein by reference in its entirety.

### TECHNICAL FIELD

Various embodiments relate to an illumination device with a solar cell as energy source.

### BACKGROUND

Conventional illumination devices are fed from an electrical storage device that is charged by means of a solar cell.

### SUMMARY

An illumination device may include a multilayer system having at least two functional layers, a supporting functional layer having a sheet-like substrate on which a photovoltaic functional layer with at least one solar cell is applied; at least one energy storage device for storing energy generated by the at least one solar cell; at least one light source that can be operated by means of the energy stored in the energy storage device; and at least one brightness sensor. The illumination device may be configured to activate or deactivate the at least one light source on the basis of a measured value sensed by the at least one brightness sensor.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a rear view of an illumination device in the form of a curtain system for an interior area of a building, in accordance with an embodiment;

FIG. 2 shows a rear view of a curtain system for an interior area of a building, in accordance with an embodiment;

FIG. 3 shows a rear view of a curtain system for an interior area of a building, in accordance with an embodiment;

FIG. 4 shows the curtain system from FIG. 1 as a sectional illustration along the line of section A-A from FIG. 1, in side view;

FIG. 5 shows an oblique view of a tent with an inventive illumination device; and

FIG. 6 shows a sectional illustration in side view of a further embodiment of an illumination device.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

Various embodiments provide a particularly simple and optically appealing possibility for illumination by the use of sunlight as energy source.

In various embodiments, an illumination device may include a multilayer system having at least two functional layers, a supporting functional layer having a sheet-like substrate on which a photovoltaic functional layer with at least one solar cell is applied; at least one energy storage device for storing energy generated by the at least one solar cell; at least one light source that can be operated by means of the energy stored in the energy storage device; and at least one brightness sensor. The illumination device may be configured to activate or deactivate the at least one light source on the basis of a measured value sensed by the at least one brightness sensor.

The illumination device may have at least one multilayer system having at least two functional layers. One of the functional layers is designed as a supporting functional layer that has a sheet-like substrate. A further functional layer has at least one solar cell as photovoltaic functional layer. A functional layer may be understood, for example, as a layer that exercises a predetermined function, such as a photovoltaic function or a light-generating function. In this case, a functional layer can have different elements that are required to fulfill the function such as, for example, electric lines, electronic circuits, a substrate etc. The functional layer can also include a plurality of layers. The functional layers need not be congruent; thus, for example, the photovoltaic functional layer may be applied on the sheet-like substrate only in a locally bounded fashion, for example with a pattern of solar cells between which gaps exist.

In addition, the illumination device may have at least one energy storage device for storing energy obtained by the photovoltaic functional layer or the at least one solar cell. The illumination device further has at least one light source that can be operated by means of the energy stored in the energy storage device. The at least one light source can in principle have any desired type of light source. It may be advantageous to use semiconductor light sources, for example light emitting diodes. The light emitting diodes can emit in one or a plurality of colors, for example white. The light emitting diodes can be present, for example, as individual LEDs or as LED modules with a plurality of LED chips. The color of the light emitting diodes can be tuned individually or as a group. It is also possible, for example, to use diode lasers. The light sources can be equipped with suitable optical devices for beam guidance, for example Fresnel lenses, collimators, beam expanders and so forth.

The illumination device additionally may have at least one brightness sensor (dusk sensor). The at least one light source can be optionally activated and deactivated on the basis of a measured value sensed by the at least one brightness sensor. Here, a brightness is understood in general as an intensity of the radiation that is acting on the brightness sensor and is averaged spatially and over a frequency band with neighboring electromagnetic radiation.

This illumination device may therefore be capable of acting as an illumination unit in addition to a light energy absorber (and thus as a sunscreen), as a function of an ambient brightness sensed by the brightness sensor. Thus, given an adequate ambient brightness, it may act only as a light energy absorber, and given a no longer adequate ambient brightness may also act as an illumination unit. A level of ambient brightness that is predetermined for the purpose of activating and deactivating the at least one light source can advantageously be variably set. Since the illumination device can be designed autonomously in relation to a public electricity supply system, it can be used particularly easily, for example without complicated assembly steps. Because, moreover, that surface that is covered by the illumination device in the event of optical irradiation can be illuminated when it is dark, a user is provided with an illumination which appears particularly appealing optically and is locally “natural”. The use of solar energy simultaneously acts as a contribution to the saving of energy. The combination of the technical functions of obtaining energy, storing energy and the release of light in an integrated solution may give rise, as a further advantage, to new possibilities of technical design in rendering it possible to experience light beyond its current known use. Such novel possibilities of configuration can be used, for example, in design-oriented fields of business such as, for example, illumination systems by architects, designers and lighting designers.

The supporting functional layer or the sheet-like substrate can be flexible, for example made from a plastic film or a fine mesh metal fabric. Consequently, it is possible to use at least the multilayer system instead of conventional flexible protective sun covers such as curtains or awning fabrics.

The supporting functional layer or the sheet-like substrate can be transparent, for example made from PI, PE or PMMA. It is thereby possible for them to be arranged, with reference to optical irradiation, as a protective layer in front of the at least one solar cell, and at the same time not to substantially prevent the incidence of light on the solar cell.

The at least one solar cell of the second functional layer can be laminated onto the first functional layer in order to be fastened in a simple, cost effective and reliable way. This may result in a compact and reliable unit that can be produced in a particularly simple way.

The at least one solar cell can be flexible. Consequently, known lengths of sun protection fabrics can be replaced in a particularly easy and naturally active fashion by the illumination device. For example, the solar cell can be present as an organic solar cell.

For the purpose of achieving a compact and reliable design, the at least one light source can be present as a light-generating functional layer or as a part of a light-generating functional layer of the multilayer system. It can, however, also be arranged next to the latter as an alternative or in addition.

The light-generating functional layer can have at least one flexible LED strip, for example the LinearLight Flex Series from the company OSRAM Opto Semiconductors GmbH. The flexible LED strip can be bonded on with its rear side, for example. It is thereby possible to replace known lengths of sun protection fabric by the illumination device in a particularly simple and naturally acting way. It is also possible to generate flexible luminous patterns. The LED strip may be configured as a front emitter and/or side emitter.

The light-generating functional layer can have at least one flexible, sheet-like OLED emitter. A homogeneous illumination of a large area that does not dazzle and is found as being particularly pleasant is thereby achieved.

The at least one light source can be applied to the multilayer system at the edge. The multilayer system can thereby be illuminated from the side, as a result of which the light sources themselves are less visible or—in the case of accommodation in a lateral enclosure (for example as piping)—not visible at all. This prevents dazzling, and an illumination without abrupt fluctuations in brightness is achieved.

Alternatively or in addition, the at least one light source can be applied to the multilayer system in a uniformly distributed fashion. Consequently, it is possible to use areas of any desired size as luminous surface without there being a drop in brightness toward the middle of the luminous surface. It is also possible thereby to achieve a higher luminosity than in the case of illumination only at the edge. In general, the light sources can be arranged spatially in any way desired, for example including irregularly.

At least the multilayer system can have an edge reinforcement, for example a firm or flexible piping, for the purpose of protection against incipient tearing and/or in order to maintain a tension.

The multilayer system can have a translucent cover layer (with one or more layers) averted from the sun made, for example, from PMMA, PC or PE. The cover layer can be white, colored or patterned. Firstly, the cover layer may be used to improve a sun protection effect and, secondly, a light distribution of the sunlight and/or of the light emitted by the at least one light-generating functional layer can be homogenized.

In order to maximize the sun protection effect, in various embodiments, the multilayer system may have at least one opaque layer (with one or more layers), the at least one solar cell being arranged on one side (facing the sun), and the at least one light source emitting on the other side (averted from the sun).

The multilayer system may, furthermore, have a UV protective layer (UV-light-blocking layer) (with one or more layers).

In various embodiments, it is possible preferably to have an illumination device in the case of which the multilayer system has the following functional layers, at least locally:
a sheet-like, flexible and transparent layer (film) for use as a cover layer facing the sun;
a, e.g. flexible, solar cell whose light gathering surface faces the transparent cover layer;
an LED luminous means, for example a flexible LED strip or a flexible OLED surface emitter; and
a translucent layer for use as cover layer averted from the sun.

The LED luminous means may radiate onto the translucent functional layer from the side, for example when used as an LED strip arranged at the side and having LED side emitters. This arrangement at the side may have the advantage that the centric surface lying therebetween has no (local) need of any luminous means, and is therefore easier to produce and weighs less. The LED luminous means may alternatively or additionally radiate onto the translucent layer from the front. It may thereby be possible to implement a surface radiating light over a large area with a regular—ideally homogenous—light pattern, it also being possible to set a luminous intensity by a spatial concentration of the LEDs. A flexible OLED surface emitter is preferred for the homogenous and simple design of the multilayer system. It is then possible, if appropriate, also to dispense with the translucent layer.

The illumination device may be figured as a curtain system, e.g. for interior areas of buildings, it being advantageously possible to use a flexible multilayer system as curtain material.

The at least one brightness sensor, the at least one energy storage device and/or at least one ballast for operating the at least one light source can then advantageously be arranged on at least one carriage. A particularly compact and reliable curtain system that is easy to take into operation is thereby provided.

The illumination device may also be configured as a sun protection cover for an outdoor area, for example in the form of a tarpaulin, an awning, a sunshade, etc.

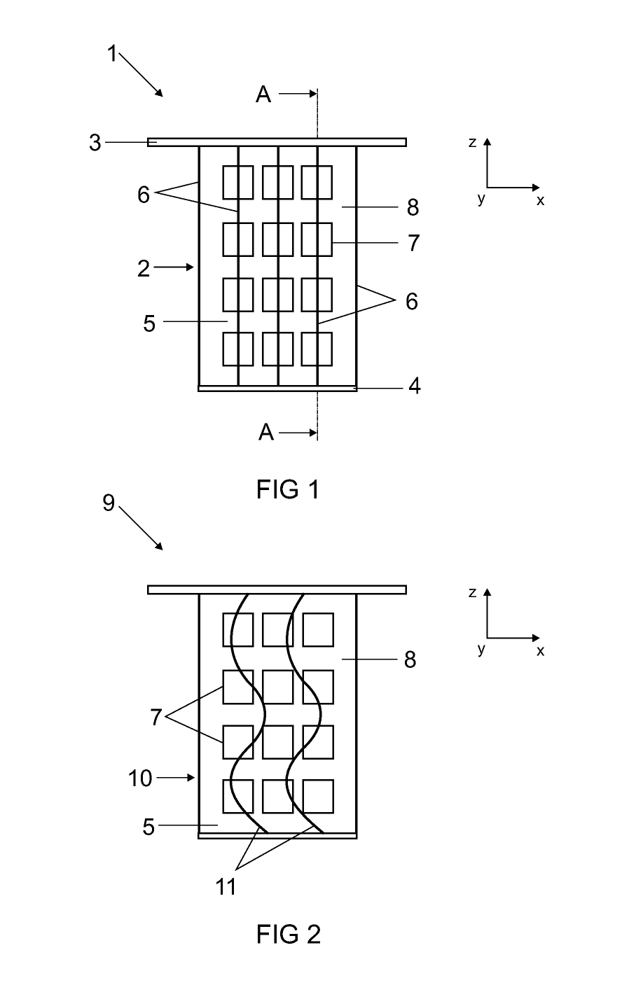

FIG. 1 shows a frontal view of a rear side of a curtain system 1 for an internal area of a building, that is to say with a view looking out from the internal area, for example onto a window. The curtain system 1 may have an at least partially flexible curtain 2 that is held at the top by means of a flexible upper edge reinforcement (top of figure) on a curtain rail 3, and has a weighted closure strip 4 on a lower side. Seen from the rear side out (looking out from the interior), the curtain 2 may firstly have a translucent cover layer 5. This translucent cover layer 5 may serve the purpose of spatially homogenizing light falling into the interior space, and thereby avoiding a blinding effect and/or a light pattern with strong fluctuations in light intensity. Present on the translucent cover layer 5 may be a light-generating functional layer with, here, five vertically arranged LED strips 6 that have light emitting diodes arranged in sequence at regular spacings (top of figure). The light emitting diodes are configured as front emitters such that they emit perpendicularly onto the translucent cover layer 5 directly, that is to say with their main beam direction. This generates a vertical strip-shaped light pattern that is scattered into the interior space by the translucent cover layer 5 and thereby is expanded and smoothed. Arranged behind the LED strips 6 is a photovoltaic functional layer with large-area solar cells (solar panels) 7. The light receiving surfaces of the solar cells 7 point forward (that is to say in the direction of view, corresponding to the y-direction), and are therefore averted from the LED strips 6. The solar cells 7 are laminated onto a front transparent cover layer 8 that is present as a transparent film. The solar cells 7 are capable of generating current when light is incident on the front side. In order to tap the current or the applied voltage, the solar cells 7 are connected via electric lines (not shown) that are also part of the photovoltaic functional layer. In order to interconnect the solar elements 7 electrically, it is advantageously possible to make use of copper tracks laminated onto the transparent film 8, or of inserted flat ribbon cables on plastic or paper substrates.

The transparent cover layer 8 and the translucent cover layer 5 have the same dimensions in width and height (that is to say in the x, z-plane). This curtain 2 therefore may form a functional multilayer system composed of a locally varying number of functional layers. Thus, at a point where an LED strip 6 runs over a solar cell 7, the curtain 2 has four functional layers, specifically the (rear) translucent cover layer 5, the light-generating layer with the LED strip 6, the photovoltaic layer with the solar cell 7 and the (front) transparent cover layer 8. By contrast, at another point the transparent cover layer 8 and the translucent cover layer 5 may rest directly on one another.

In an illustration analogous to FIG. 1, FIG. 2 shows a curtain system 9 with a curtain 10 in the case of which, by comparison with the embodiment according to FIG. 1, the LED strips 6 do not run vertically upward linearly, but run in a wavy fashion. However, the position of the LED strips 6 is not restricted in principle; said LED strips can also, for example, be aligned obliquely or horizontally, or else have an open or closed free form (a ring form, for example).

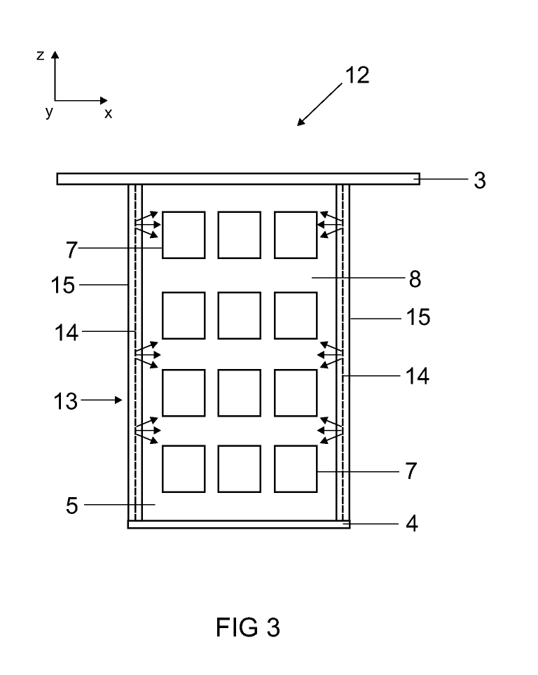

In an illustration analogous to FIG. 1 and FIG. 2, FIG. 3 shows a curtain system 12 with a curtain 13 in the case of which—now in contrast to the embodiments in accordance with FIG. 1 and FIG. 2—only two LED strips 14 (drawn in with dashes) are arranged on the left-hand and right-hand edges of the curtain. These LED strips 14 are designed as side emitters, that is to say that their LEDs are aligned such that they radiate laterally into the curtain 2, as indicated by the arrows. As a result, the translucent cover layer 5 is illuminated from the side and because of its scattering property at least partially emits the light in planar fashion into the interior space. The two LED strips 14 are covered with lateral strips 15 in order to be protected and to achieve an impression that is of high visual quality. In order to increase the luminosity of the optical radiation output into the interior space, it is possible for there to be present a reflective functional layer that reflects light generated by the at least one light source onto the translucent cover layer 5.

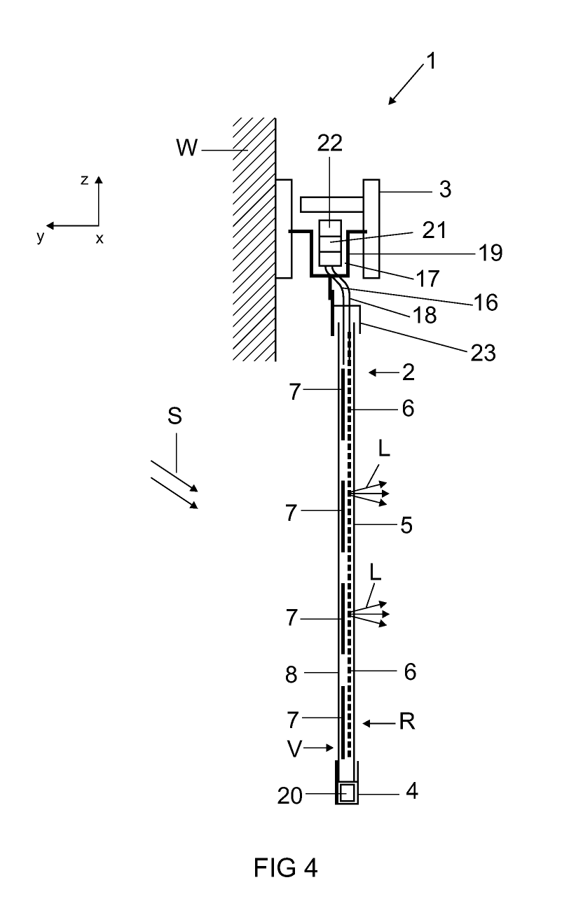

FIG. 4 shows the curtain system 1 as a sectional illustration along the line of section A-A from FIG. 1, in side view. The curtain 2 has the transparent cover layer 8 on its front side V, onto which light, here: sunlight S, is incident. Laminated on the inside of the transparent cover layer 8 are the solar cells 7 that collect the sunlight S incident through the transparent cover layer 8 and convert it into electric current. Furthermore, the solar cells 7 block out the light incident on them such that the curtain 2 serves as sun protection. The current generated by the solar cells 7 is conducted to an electrical storage device 17 via electric lines 16. The electrical storage device 17 can, for example, have an accumulator, a rechargeable battery, a supercapacitor, etc. The LED strip 6 is fastened in a vertically running fashion on the rear side of the solar cells 7 and in the gaps between the solar cells 7 on the rear side of the transparent cover layer 8. The LED strip 6 of the light-generating functional layer with its light emitting diodes (not illustrated here) draws its current from the electrical storage device 17 via an electric supply line 18. On its rear side R, the curtain 2 is sealed over its entire surface by the translucent (opaque) cover layer 5. The curtain 2 is fastened on the curtain rail 3 via a carriage 19 suspended in a sliding fashion on the curtain rail 3, and can be drawn apart and pushed together again thereon like a net curtain. To this end, the curtain 2 with its multilayer system 5, 6, 7, 8 is closed at the top by means of the flexible upper edge reinforcement 23, for example a curtain rail. The multilayer system can be fastened on the edge reinforcement 23, for example by clamping, positive locking or bonding. The electric lines 16, 18 can be brought together at the upper end of the curtain 2 in order then to be guided through openings (top of figure) in the edge reinforcement 23 and further to be connected to the energy storage device 17 and an electronic controller 21 (see below).

Use may be made of commercially available curtain rails 3. The curtain 2 can be fastened on the carriage 19 by screwing, riveting, bonding, a Velcro fastener etc. Similar to the case of net curtains, weights 20 are to be found in the lower closure strip 4 in order to keep the curtain 2 tight. The solar cells 7 may be of flexible design, for example be present as flexible organic solar cells, in order to obtain a soft drop of the curtain 2, as a result of which the latter can be configured yet more like a net curtain. In order to improve the flexibility of the curtain 2, a flexible OLED emitter covering the entire surface can be used instead of the LED strips 6. Such a large-area emitter also has the advantage that it is possible to achieve a completely homogeneous generation of light.

Located on the carriage 19 and therefore in a fashion displaceable therewith, are the electrical storage device 17, an electronic controller 21 in the form of a ballast for driving the LED strip 6 or the LED strips 6 (in general: the light-generating functional layer), as well as a brightness sensor 22. The electronic controller 21 may have an electronic driver for the light emitting diodes of the LED strip 6. The electronic controller 21 controls or regulates a feeding of current to the LED strip 6 or the LED strips 6. The electronic controller 21 is connected to the brightness sensor (dusk sensor) 22 that senses the ambient brightness. When a predetermined brightness threshold value is reached or dropped below, the electronic controller 21 feeds the LED strips 6. In other words, as the brightness decreases, the curtain 2 or the LED strips 6 is/are switched on starting from a predetermined threshold value. If the ambient brightness lies above the brightness threshold value, the electronic controller 21 switches off the LED strips 6 again. Alternatively, as ambient brightness decreases, the LED strips 6 can gradually shine more strongly. In the embodiment shown here, the LED strips 6 shine from the front into the interior space, that is to say from the rear side R of the curtain 2, as indicated by the associated arrows L. In this case, the light emitted by the LEDs of the LED strips 6 penetrates the rear translucent cover layer 5 by means of which the distribution of luminosity is smoothed, and thus the light pattern perceived on the rear side R of the curtain 2 is “smeared”. Fitting the energy storage device 17, the electronic controller 21 and the brightness sensor 22 on the carriage 19 results in maintaining a position of the curtain 2 relative to these elements 17, 21, 22 that is fixed; consequently, the lengths of the electric lines 16, 18 can be kept short, and their mechanical loading is minimized. The curtain rail 3 can be fastened on a wall W.

The illumination device 1 thus produces a modular lighting system comprising solar panel, LED panel, energy storage device, ballast, mechanical substrate and dusk sensor.

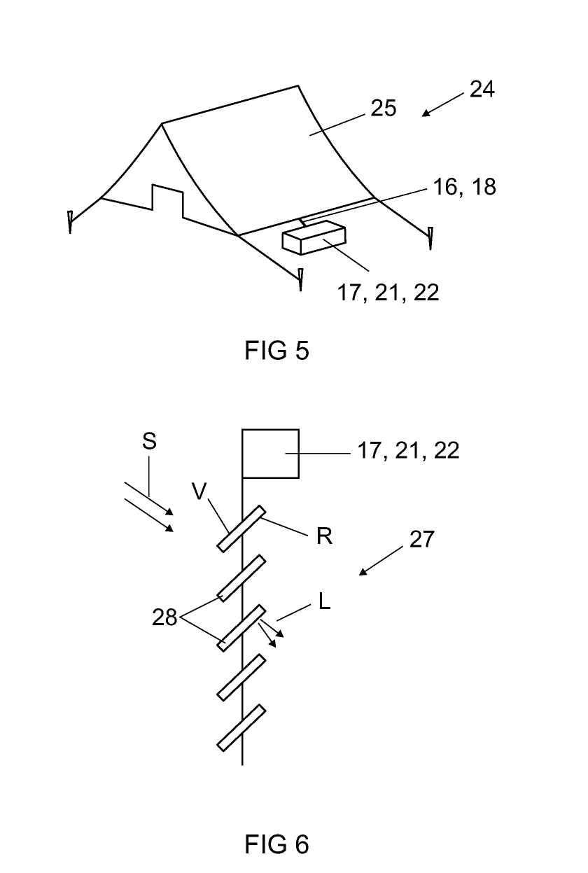

FIG. 5 shows a tent 24 whose material of the tent tarpaulins, or at least the tent tarpaulin(s) used as a roof, is constructed from a multilayer system 5, 6, 7, 8, as described above. The tent roof 25 therefore serves during the day as sun protection and can serve as an illumination source given darkness inside. For use in the area outside, the multilayer system also has an outermost UV-resistant film, or the layers 5 to 8 are UV resistant. Additionally, the cable leadthroughs to the batteries and electronic controller must be enclosed by sealing strips, and the latter must be mounted separately in a moisture-proof box. The enclosing strips are sealed with silicone. The cable leadthroughs on the surrounding strips for leading through the electric lines 16, 18 to the energy storage device 17 and the electronic controller 21 are enclosed by sealing strips in order to protect against penetration of moisture. The energy storage device 17 and the electronic controller 21 are further accommodated separately in a moisture-proof box 26. In the case of use as a sunshade or canopy, preference is given to a support structure in order not to expose the luminous curtain to large mechanical loads.

FIG. 6 shows a further exemplary embodiment of an inventive illumination device in the form of a venetian blind 27 in the case of which the sheet-like substrate (top of figure) is of rigid design, each of the slats 28 of the venetian blind having a solid substrate. In this case, the substrate is opaque and has solar cells on its front side V (top of figure), while on its rear side R an LED strip (top of figure) is applied over the length of the slats 28 and covered by a translucent film. The rear side R of the venetian blind 27, more precisely: the rear side of the individual slats 28, can thereby serve as luminous surface.

Of course, the various embodiments is not restricted to the embodiments described herein.

Thus, an optically attenuating or opaque layer may additionally be present in the curtain between the solar cells and the light sources; this results in maximum protection against the sun. Apart from LED strips, it is also possible to use other LED arrangements, for example LED networks or LED chains. Apart from light-emitting diodes, it is also possible to use other light sources, for example laser diodes or other semiconductor light sources. The light sources can be equipped in general with one or more optical systems for beam guidance, in particular for beam expansion. It is also possible for broadly emitting light emitting diodes to be used as light emitting diodes, since it results in a more uniform light pattern. The size, the spacing and the number of the solar cells can be matched with the application, for example in order to achieve a far reaching flexibility of the curtain even in the case of inflexible solar cells it is possible to use many small solar cells that can be at an angle to one another and can be twisted relative to one another from otherwise flexible positions.

The illumination device can be used as, or in conjunction with, an awning, a sunshade, a canopy and much more.

### LIST OF REFERENCE SYMBOLS

1 Curtain system
2 Curtain
3 Curtain rail
4 Closure strip
5 Translucent cover layer
6 LED strip
7 Solar cell
8 Transparent cover layer
9 Curtain system
11 Curtain
12 Curtain system
13 Curtain
14 LED strip
15 Lateral strip
16 Electric line
17 Electrical storage device
18 Electric line
19 Running carriage
20 Weight
21 Electronic controller
22 Brightness sensor
23 Upper edge reinforcement
24 Tent
25 Tent roof
26 Box
27 Venetian blind
28 Slat
R Rear side
S Sunlight
V Front side
W Wall

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. An illumination device, comprising:
a multilayer system having at least two functional layers, a supporting functional layer having a sheet-like substrate on which a photovoltaic functional layer with at least one solar cell is applied;
at least one energy storage device for storing energy generated by the at least one solar cell;
at least one light source that can be operated by means of the energy stored in the energy storage device; and
at least one brightness sensor,
wherein the illumination device is configured to activate or deactivate the at least one light source on the basis of a measured value sensed by the at least one brightness sensor.

2. The illumination device as claimed in claim 1, wherein the supporting functional layer is flexible.

3. The illumination device as claimed in claim 1, wherein the supporting functional layer is transparent.

4. The illumination device as claimed in claim 1, wherein the at least one solar cell of the photovoltaic functional layer is laminated onto the supporting functional layer.

5. The illumination device as claimed in claim 1, wherein the at least one solar cell of the photovoltaic functional layer is flexible.

6. The illumination device as claimed in claim 1, wherein the multilayer system has a light-generating functional layer with the at least one light source.

7. The illumination device as claimed in claim 1, wherein the light-generating functional layer has at least one flexible light emitting diode strip.

8. The illumination device as claimed in claim 1, wherein the light-generating functional layer has at least one flexible, sheet-like organic light emitting device emitter.

9. The illumination device as claimed in claim 1, wherein the at least one light source of the light-generating functional layer is arranged on the multilayer system at the edge.

10. The illumination device as claimed in claim 1, wherein the at least one light source of the light-generating functional layer is arranged in a uniformly distributed fashion.

11. The illumination device as claimed in claim 1, wherein the multilayer system has an edge reinforcement.

12. The illumination device as claimed in claim 1, wherein the multilayer system has a translucent cover layer averted from the sun.

13. The illumination device as claimed in claim 1, wherein the multilayer system has a UV-light-blocking layer.

14. The illumination device as claimed in claim 1, wherein the multilayer system serves as curtain material, and the at least one brightness sensor, at least one of the at least one energy storage device and the at least one electronic controller configured to operate the at least one light source are arranged on at least one running carriage.

15. The illumination device as claimed in claim 1, wherein the multilayer system is designed as a tarpaulin for external lighting.
